(19) United States
(12) Patent Application Publication
(10) Pub. No.: US 2024/0203722 A1
(43) Pub. Date: Jun. 20, 2024

(54) A SYSTEM TO GENERATE A HIGH YIELD OF NEGATIVE IONS FOR ICP-MS

(71) Applicant: Kimia Analytics Inc, Thomhill (CA)

(72) Inventors: Gholamreza JAVAHERY, Thornhill (CA); Sina ALAVI, North York (CA); Javad MOSTAGHIMI, Mississauga (CA); Kaveh KAHEN, North York (CA)

(21) Appl. No.: 18/286,897

(22) PCT Filed: Apr. 11, 2022
(86) PCT No.: PCT/CA2022/050559

§ 371 Date: Oct. 13, 2023

(30) Foreign Application Priority Data
Apr. 11, 2022 (WO) PCT/CA2022/050559

(51) Int. Cl. H01J 49/10; H01J 49/04; H01J 49/06

(52) U.S. Cl. CPC H01J 49/105; H01J 49/0422; H01J 49/062

(57) ABSTRACT

A new ICP-MS ion transfer method is disclosed capable of generating and transporting high yields of positive and negative ions, with the ability of quenching undesirable meta-stable ions and neutrals while using the existing ICP torch. A dopant is added in various pressure regions of the mass spectrometer interface, where reaction time is suitable for gas-phase ion/molecular reaction to occur. Introducing dopants or analyte in the provided RF confinement fields generates a high yield of negative ions in various pressure regions of mass spectrometer. A mechanism utilizing free electrons and meta-stable neutrals (Ar* for example) is used to form high yields of negatively charged elements which are originally atomized within the plasma and are stable in negative ionic form.

### FIELD OF INVENTION

The present invention generally relates to ICP-MS and particularly to a method for ion generation for ICP-MS.

### BACKGROUND

Inductively coupled plasma mass spectrometry (ICP-MS) is a type of mass spectrometry that uses an Inductively coupled plasma (ICP) to ionize the sample. The plasma in ICP has a high temperature (5000-10000 K), which atomizes, ionizes, and excites the constituents of any sample. This process results in the formation of numerous excited species in the plasma, including atomic and polyatomic ions and meta-stable atoms and molecules. This system is a highly efficient ion source since it can produce metallic cations and to some extent non-metallic cations. It can detect different isotopes of the same element, which makes it a versatile tool in isotopic labeling.

In general, the ICP has a poor efficiency in generating atomic anions at a significant level. Generation of a high yield of negative ions has been a challenging endeavor in ICP-MS. Production of negative ions is necessary to obtain a complete profile of the sample (for example nutrition elements in the human body such as Phosphorous (P), Sulfur (S), Chlorine (Cl) and Iodine (I)). Current ICP-MS systems are unable to generate and detect these elements to a significant level; since they cannot ionize these species efficiently.

Argon (Ar) is commonly used in ICP-MS (other gases, such as helium, are also used but are less common). An Ar plasma produces a high number of Ar meta-stable neutrals (Ar*) and Ar metastable ions (Ar*⁺) in addition to other cations. Ar* and Ar*⁺ entering the mass spectrometer are known to cause negative effects. Therefore, reduction of Art and Ar*⁺ significantly improves the performance of ICP-MS devices.

Mass spectrometers normally operate under vacuum, while the ions are created in atmospheric pressures. There are different pressure regions in the MS system, varying from atmospheric level to the vacuum. Due to the high flow of gas through the entrance aperture (orifice) of the MS, all the constituents of the plasma may enter the MS. Subsequently, charge separation occurs downstream of the entrance aperture where momentum of the flow becomes less, and electrostatic fields become the dominant force affecting the ions. Therefore, current ICP-MS systems typically use various forms of ion deflectors to separate the sample ions from the rest of the species and prevent meta-stables, neutrals, and photons from entering the mass analyzer.

FIG. 1 shows a prior mass spectrometer that operates under different pressure regions. The inductively-coupled plasma (ICP) ion source 100 works at the atmospheric pressure, and the mass spectrometer 190 works in vacuum. The analytes are typically injected into the ion source in the form of an aqueous solution to be ionized by the intense heat of the plasma. As the ions 105 are generated inside the plasma, they go through an orifice (aperture) 115 and expand into a lower pressure region 116. They may then enter a first skimmers 151 and expand into a lower pressure region 117. The expansion process may continue through another skimmer 152 to even lower pressures 118.

In most mass spectrometers, some device is used to remove all unwanted species and prevent them from entering the later stages of the MS. These devices mainly use an ion deflector, which comes in a variety of different types. An ion deflector only deflects the ions and allows them to enter the mass analyzer. All other neutral species, including the photons generated by the plasma, are unaffected by the ion deflected and are evacuated or collide with the walls of the deflector, making sure they do not enter the subsequent stages of MS. For example, the ions may go through an ion guide 161 and a lens 171 while the pressure is gradually decreased until a low pressure 119 is reached before entering the last stage of the mass spectrometer 190. Different systems may have different number of stages, skimmer and ions guides. A set of vacuum pumps control the pressure in different stages.

The devices that are typically used to prevent the unwanted species from entering the MS are complicated and expensive. All of these devices use some form of electric/magnetic field to manipulate the ions. This necessitates extensive electronic circuit design which adds to the cost and complexity of the system. More importantly, a significant portion of the desired ions are lost in the process along with the unwanted species due to the inefficiencies associated with these devices.

### BRIEF SUMMARY OF THE INVENTION

A new ICP-MS ion transfer method is disclosed capable of generating and transporting high yields of positive and negative ions, with the ability of quenching undesirable meta-stable ions and neutrals while using the existing ICP torch. This system and method do not use any electrostatic deflector, ion guide, or similar types of deflectors as commonly used in conventional mass spectrometers to eliminate the unwanted species and photons. A mechanism utilizing free electrons and meta-stable neutrals (Ar* for example) is used to form high yields of negatively charged elements (which are stable in negative ionic form) which are originally atomized within the plasma. This can be achieved farther away from the plasma source where the pressure is lower than atmosphere, the temperature is cold enough, and negative ions are stable.

The present device and method generate a high number of negative ions. Negative analytes can be produced at various pressure regions of the MS when anions, free electrons, and meta-stables (originally present in the plasma) react with an appropriate catalyst dopant or directly with the analyte itself.

The present system and method comprise of the following novel processes:
Adding the right dopant in various pressure regions of the mass spectrometer interface, where reaction time is suitable for gas-phase ion/molecular reaction to occur.
Introducing dopants or analyte in the provided RF confinement fields for generating a high yield of negative ions in various pressure regions of mass spectrometer.
Introducing the right quenching gas at various pressure regions for quenching unwanted meta-stable neutrals. Quenching the meta-stable plasma gas ions/neutrals before entering the mass analyzer is an enormous improvement. The right quenching gas can quench all of the unwanted metastable neutrals, which is an important advancement.

The present system utilizes a mechanism for the generation of negative ions which can work with any other plasma gases, i.e., He, Ne and di-atomic and tri-atomic molecular gases. A new means for introducing analytes or sample to be analyzed by the mass spectrometer is introduced through inlet ports (at various pressure stages of the MS) other than through the injector tube of the ICP torch.

In the present system, the negative ions are formed after the source (the ICP), and in later stages of the MS where the pressure is lower than atmosphere. For example, in a low-pressure cavity between the sampler cone and skimmer cone; that is within the sampling interface. None of the previous ICP-MS systems were able to form or detect negative ions.

In the present system, the flow is bent from the sampler orifice to the skimmer (i.e., a flow driven cavity). This is a new method of blocking photons (due to the off-axis design) and meta-stable argon species in ICP-MS. In addition, in the present system, meta-stable species are eliminated and are used to form negative ions “at the same time”.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a prior art ICP-MS system.

FIG. 2 shows the first embodiment of the present system with dopant introduction in the cavity and two skimmers.

FIG. 3 shows the second embodiment of the present system with dopant introduction in the cavity, one skimmer, and one RF-only ion guide after the skimmer.

FIG. 4 shows the third embodiment of the present system with dopant introduction in the cavity and two RF-only ion guides.

FIG. 5 shows the fourth embodiment of the present system with dopant introduction in the second pressure region of the MS within the first ion guide.

FIG. 6 shows the fifth embodiment of the present system with dopant introduction in the third pressure region of the MS within the second ion guide.

FIG. 7 shows the sixth embodiment of the present system with dopant introduction in the fourth pressure region of the MS within the third ion guide.

FIG. 8 shows the seventh embodiment of the present system with dopant introduction in the first pumping region the MS that has two skimmers.

FIG. 9 shows the eights embodiment of the present system with dopant introduction in the first pumping region of the MS that has one skimmer and one ion guide.

FIG. 10A shows image of the present device in operation.

FIG. 10B shows image of the present device in operation.

FIG. 10C shows image of the present device in operation.

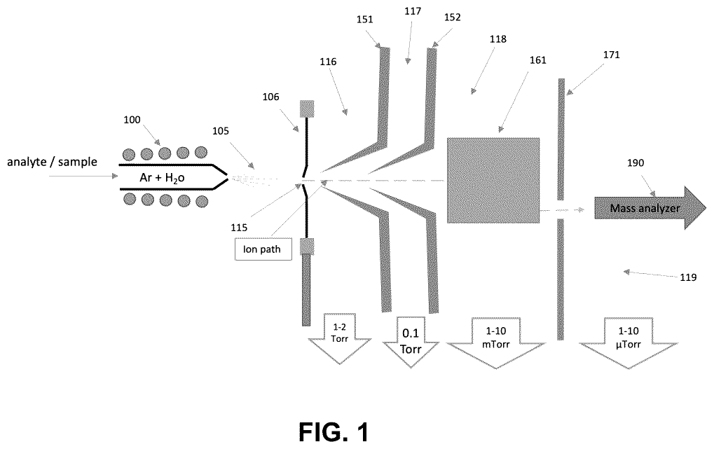

### DETAILED DESCRIPTION

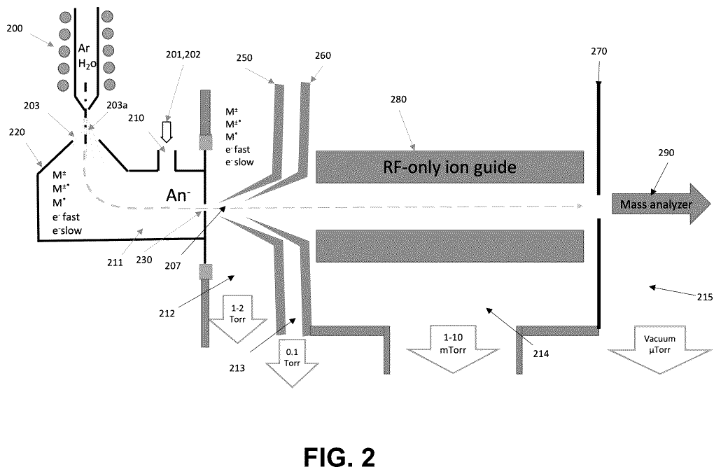

FIG. 2 shows the main elements of the present system. The system comprises of a section for the introduction of a dopant or analyte into the sample chamber prior to entrance to the MS and after the ionization source.

A cavity (chamber) 220, which is field-free, is configured to receive charged species and transport them purely by momentum of the background gas to the MS. This field-free cavity does not use any electrostatic or other electric or magnetic fields for ion separation, as commonly used in ion deflectors. It is mainly a flow driven cavity. The pressure inside the cavity is lower than atmosphere. This is another innovative aspect of the present invention. The pressure inside the cavity is determined by the size of the sample

All species (positive, negative and meta-stable ions, neutrals, free electrons, and photons) generated from the ICP torch 200 will enter the cavity 220, having walls, from a first inlet 203. One or multiple inlets 210 are provided for introducing an appropriate dopant 201 or analyte 202 of interest at various pressure regions. Proper dopant can react with interference ions and meta-stable neutrals/ions in any pressure region provided. An off-axis exit 230 (in which the axis of the system 207 is not aligned with the axis 203a of the inlet 203) at the cavity allows the mixture in the cavity to leave the cavity as they flow with the fluid flow while blocking the photons (which can generate signal noise if they reach the detector) from entering the MS as they collide with the walls of the cavity 220. In the first embodiment of the present system, a dual-skimmer (FIG. 2) 250 and 260 followed by an ion guide 280 allow to pressure drop from the pressure inside the cavity 211 to lower pressures in different pressure stages, 212, 213, 214, and 215. The dimensions of the cavity are configured to allow for proper mixing and reaction times of the dopant with the species. A lens 270 at the exit of the ion guide 280 allows species on the vicinity of the system axis 207 to enter the MS 290.

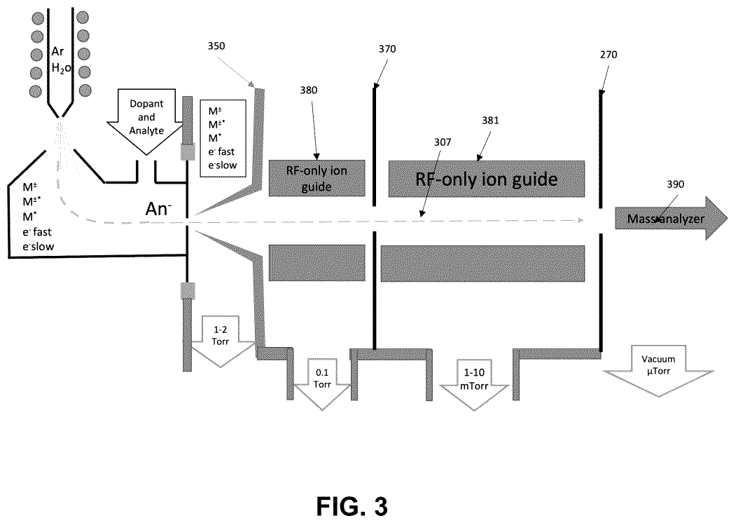

FIG. 3 shows the second embodiment of the same invention that uses one skimmer 350 and an ion guide 380. Since after the first skimmer 350, the momentum of the flow is reduced, and the electrostatic forces become dominant, species start to diverge from the central axis. Therefore, an ion guide 381 with upstream and downstream lenses 370 and 270, respectively, are used as a more effective way in controlling the ions and focusing their flow around the central axis. An RF-only ion guide is used for this purpose. The most probable charge separation region is mainly on the central axis 307 is in the ion guide 380, where single polarity charged species pass. Complete charge separation occurs in the RF ion guide region 307 of 381. Electrons become unstable due to RF. Single polarity ions, meta-stable neutrals and ions are formed.

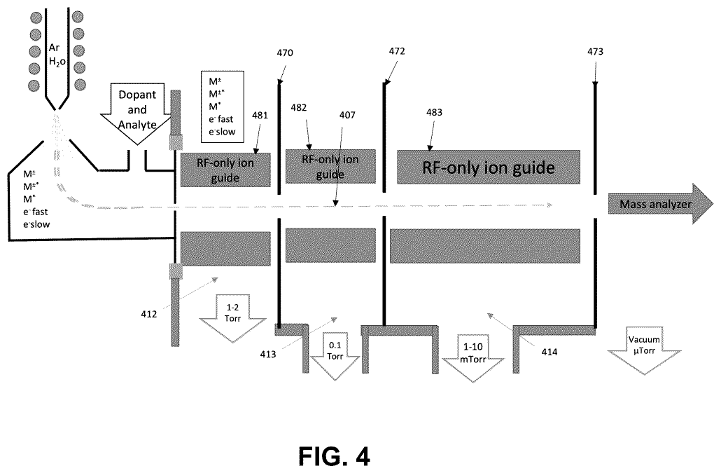

FIG. 4 shows a third embodiment of the same invention, in which two ion-guides 481 and 482 separated by a lens 470 are used successively instead of the two skimmers of the first embodiment. The most probable charge separation region is around the central axis 407 of the system and in the second ion guide 482. Single polarity charged species pass through this region. Another RF-only ion guide 483 separated from the second ion guide 482 with a lens 472 is used for complete charge separation. In this ion guide 483, electron become unstable due to RF and single polarity ions, meta-stable neutrals and ions are formed and go through lens 473 to enter the MS.

The dopant addition is the critical aspect of quenching the metastables. Metastable ions and neutrals are formed inside the plasma. Neutrals are more troublesome because they do not have a charge and they cannot be filtered with the mass analyzer or the ion guide. Although most of these metastable are formed inside the plasma, some of them can also be formed in later stages of the mass spectrometer. For example, with Ar as the main plasma gas, neutral meta-stable Ar (Ar*) can be formed by the following reactions:

Ar*⁺+Ar→Ar*⁺Ar⁺

M⁺+Ar→Ar*⁺M+e⁻

H*⁺Ar→Ar*⁺H

A metastable argon ion reacts with an argon atom, which is neutral, and turns it into a metastable, while itself going back to the ground state. Or if a molecule or an ion M⁺, which has a higher ionization potential than the metastable energy of argon, collide with the argon atom it can form a metastable argon atom and the species itself becomes neutralized and one electron is released in the process. Or if another metastable atom H* with a higher metastable energy than that of argon collides with an Ar atom, it can form a metastable argon while the atom itself relaxes to the ground state. In addition, other reactions can occur at the later stages of the mass spectrometer to form metastable argon atoms.

In the present system and method, a quenching mechanism is used for quenching meta-stable neutrals and ions, as destruction of Ar* is desirable and beneficial for the MS. The process that is used in the present system to neutralize the species is penning ionization. Penning ionization is known to be a very effective ionization process in which the excess energy of a meta-stable dissipates into the reacting partner, causing the reactant to be ionized, if the ionization energy of reactant is less than the meta-stable energy of the plasma gas. For example, Ar* ground state is a doublet with energies of 11.4 and 11.6 eV. Any reactant X with an ionization energy lower than this will be readily ionized:

Ar*⁺X→X⁺+Ar+e⁻

Table 1 provides a list of suitable compounds with ionization energy less than that of Ar* (i.e., <11.4 eV). These compounds can be used to quench the energy of Ar* and become ionized themselves. Any of these compounds can be introduced in various pressure regions, which result in transfer of energy from Ar* and ionization of the compound itself. Subsequently, these ionized compounds can easily be filtered by MS. The same scheme can be used to eliminate interference ions from ions of interest, for example, it can be used to remove the interference of ArO⁺ on Fe⁺.

TABLE 1
List of some suitable compounds with ionization
energy less than that of Ar*

| Formula | Molecule | m/z (D) | IE(eV) |
|---|---|---|---|
| C₄H₆O | Butenal | 70.0 | 9.7 |
| C₂H₄ | Butene | 28 | 9.51 |
| C₄H₆ | Butyne | 54.0 | 9.57 |
| C₃H₄ | Allene | 40.0 | 9.7 |
| C₃H₆O | Aceton | 58.1 | 9.7 |
| C₃H₆ | Propene | 42.0 | 9.7 |
| C₃H₆ | Propene | 42 | 9.7 |
| C₆H₁₀ | Hexyne | 82.1 | 10.07 |
| NH₃ | Ammonia | 17.0 | 10.07 |
| C₅H₈ | Pentyne | 68.0 | 10.1 |
| C₆H₁₄ | Hexane | 86 | 10.13 |
| CH₂ | Methylene | 14 | 10.4 |
| C₂H₄ | Ethylene | 28.0 | 10.5 |
| C₆H₁₄ | Hexane | 86 | 10.13 |
| CH₂O₂ | Formic acid | 42 | 9.7 |

### Mechanism for Generation of Negative Ions

In an Ar plasma, these are the predominantly generated compounds:

Inside the plasma, there are Argon ions, Argon metastable ions, the metastable neutrals, fast electrons, and slow electrons.
Ar^{±}, Ar*^{±}, Ar*, fast free e⁻, slow free e⁻

### Mechanism of Production of Negative Ions in an Ar Discharge can be Through the Following Routes:

Case-1: A molecule or ion is negatively ionized by electron attachment. The resulting negative ion then reacts with the analyte of interest (An) and turns it into a negative ion by way of electron transfer.

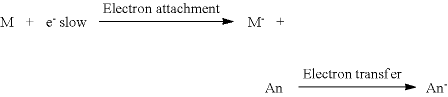

Case-2: A metastable neutral argon atom reacts with a dopant with an ionization energy less than 11.4 eV. The metastable energy of argon atom is dissipated into the dopant molecule and ionize it, while the argon atom itself relaxes into ground state. A free electron will also be released in this reaction which can ionize an analyte (An) through electron attachment.

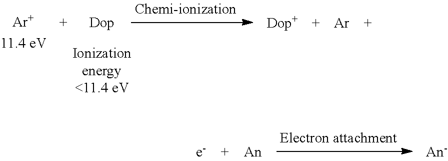

Case-3: A free slow electron form in previous stages can directly ionize an analyte through electron attachment.

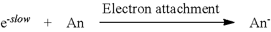

Case-4: a negative ion collides with an analyte and, provided that the electron affinity of the analyte is higher, it will capture that electron from the negative ion and becomes negatively charged itself.

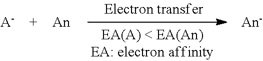

All of the reactions mentioned above can be used to form negative ions.

### Formation of Negative Ions Inside the Cavity

The following cases may occur when a dopant is added inside the cavity.

Case-1: Formation of negative analyte ion (An) via direct electron attachment:

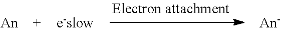

Case-2: Formation of negative analyte ion via introduction of a proper dopant:

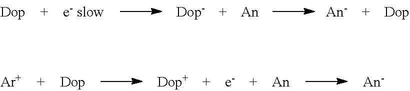

These reactions might proceed downstream in any pressure regions.

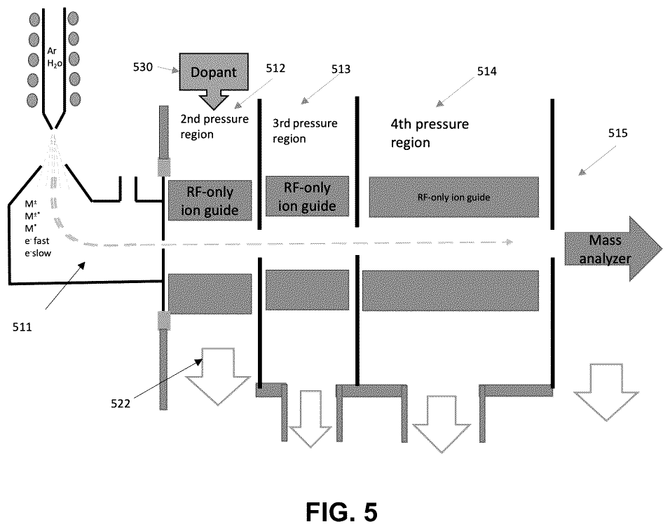

FIG. 5 shows another embodiment of the present invention, the system has first 511, 2d 512, 3^{rd} 513, 4^{th} 514, and fifth 515 pressure regions. The dopant 530 is added in the second pressure region 512, in which the pressure is controlled by a pump 522. In this case, electrons are still present in this region due to high flow of gas from the cavity. The following cases may occur.

Case-1: Formation of negative analyte ion via direct electron attachment

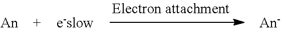

Case-2: Formation of negative analyte ion via introduction of a proper dopant

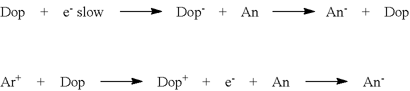

These reactions might proceed downstream in any pressure regions.

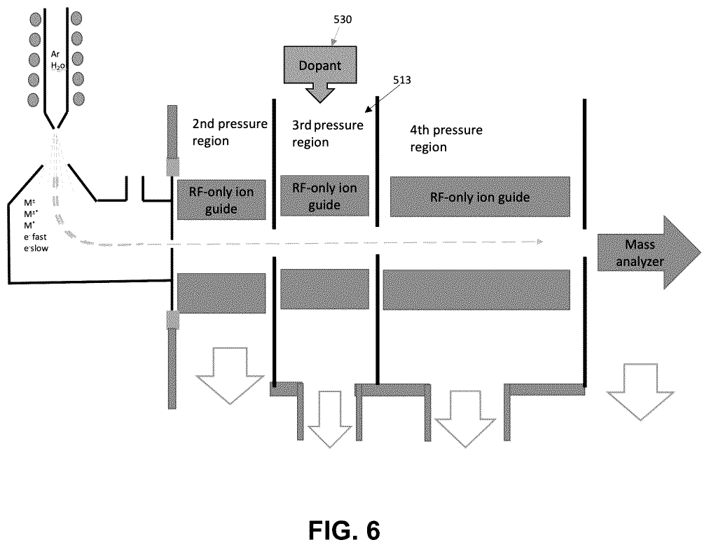

FIG. 6 shows another embodiment of the present invention, in which the dopant 530 is added in the third pressure region 513, and negative ions are generated in that region.
Electrons are no longer present in this region.
Formation of negative analyte ion via introduction of a proper dopant can occur:

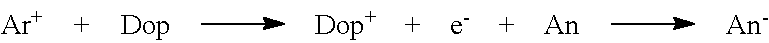

These reactions might proceed downstream in any pressure regions.

In the third pressure region of the mass spectrometer, electrons are mostly lost because of collision with other heavier species or various walls of the orifices and MS. Therefore, there are no free electrons in these regions. Then, dopant can be introduced and through ionization of the dopant, negative ions are formed.

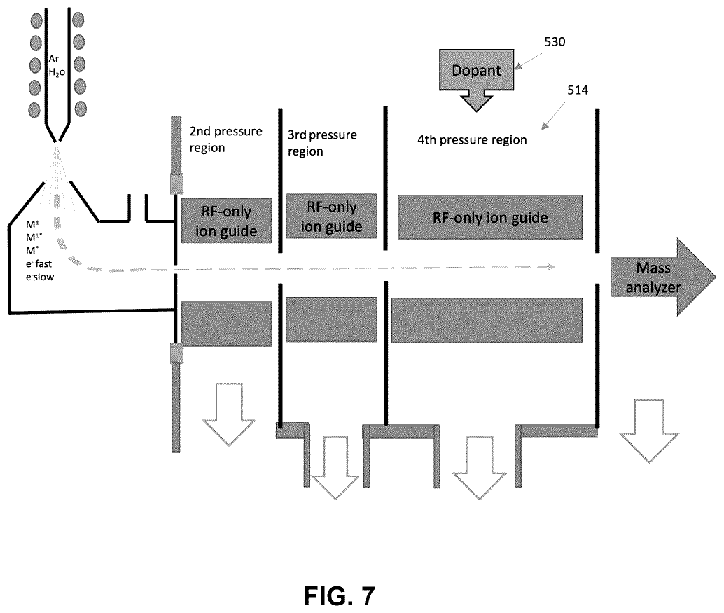

FIG. 7 shows another embodiment of the same invention, in which the introduction of the dopant 530 and formation of negative ions is in the fourth pressure region 514.
Electrons are no longer present in this region
Formation of negative analyte ion via introduction of a proper dopant can occur:

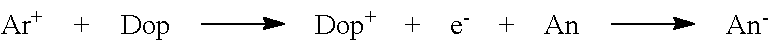

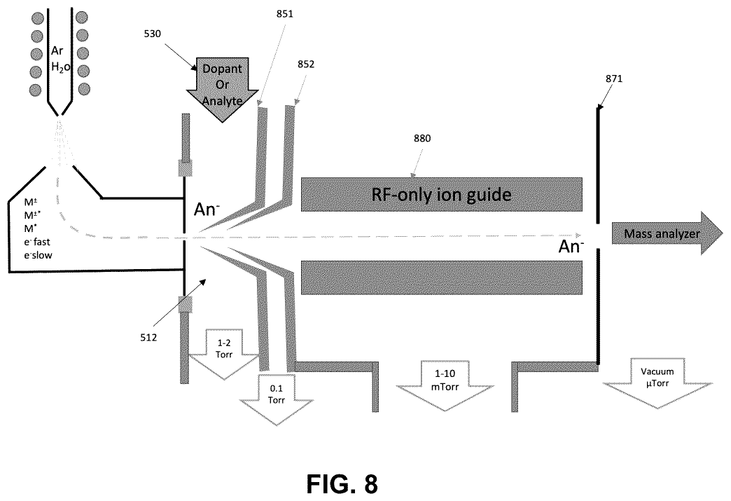

FIG. 8 illustrates another embodiment of the present invention, in which introduction of dopant 530 or analyte is in the first pumping region 512 of the MS that has two skimmers 851, 852. The species then enter the ion guide 880 followed by a lens 871

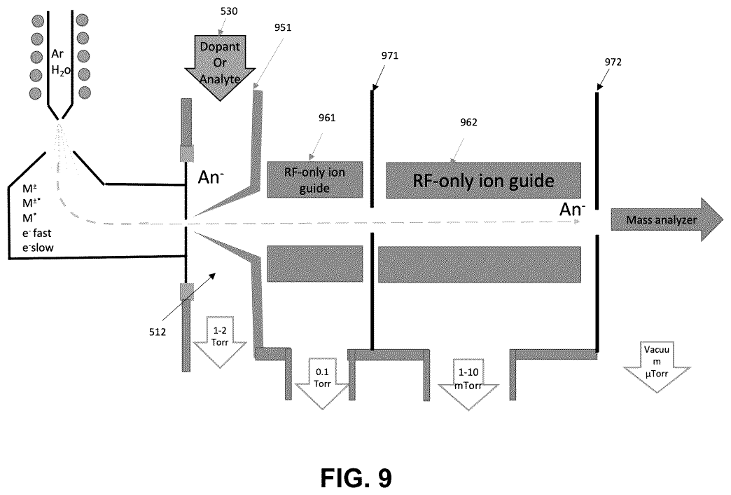

And FIG. 9 illustrates another embodiment of the present invention, in which introduction of dopant 530 or analyte is in the first pumping region 512 of the MS that has one skimmer 951 and one ion-guide 961. A second ion guide 962 separated from the first one with a lens 971 receives species and provides ions to the MS through lens 972.

In all these systems, the dopant is selected to have an ionization energy lower than the energy of the meta-stable neutrals. Therefore, the energy of the meta-stable neutrals is dissipated into the molecules of the dopant to quench the meta-stable neutrals and to generate dopant ions and free electrons in any of the pressure stages of the system. The free electrons ionize the analytes through electron attachment to form negative analyte ions in any of the pressure stages of the system. A molecule or ion is negatively ionized by electron attachment, then transfers the electron to the analytes through electron transfer to form negative analyte ions in any of the pressure stages of the system. The dopant molecule is negatively ionized by electron attachment, then transfers the electron to the analytes through electron transfer to form negative analyte ions in any of the pressure stages of the system. In this system, the meta-stable neutrals are quenched generating high yields of negative ions for inductively coupled mass spectrometer (ICP-MS).

The background gas and analytes are injected into the ICP torch to form a plasma comprising of positive and negative ions, meta-stable ions and neutrals, and molecules of the background gas, and free electrons. The plasma enters into the cavity that sustained at a pressure lower than atmosphere. A dopant is also injected into the cavity and is mixed with the plasma to quench meta-stable neutrals and form a mixture. Then the mixture is directed out of the cavity by the momentum of the background gas towards a mass spectrometer for analysis. As noted the background gas can be helium (He), nitrogen (N₂), argon (Ar), oxygen (O₂), hydrogen (H₂), air, water vapor or a combination thereof. The dopant is selected such that it has an ionization energy lower than the meta-stable energy of the meta-stable neutrals. For example for Ar meta-stable neutrals, dopants comprise of Butenal, Butene, Butyne, Allene, Acetone, Propene, Hexyne, Ammonia, Pentyne, Hexane, Methylene, Ethylene, Hexane, Formic acid, or a combination thereof react with and quench Ar meta-stable neutrals and become ionized themselves.

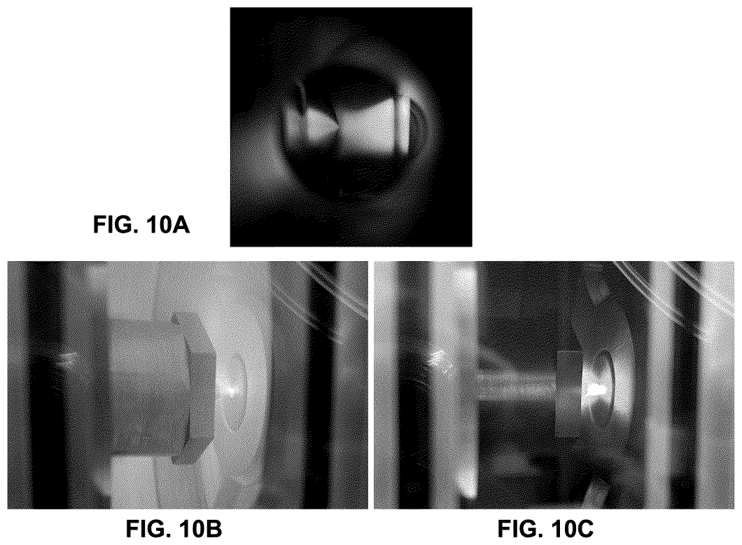

FIG. 10A shows and embodiment of the present invention in which an argon ICP torch is placed in front of the sampler orifice which is coupled with an off-axis cavity. The ions generated by the argon plasma are sucked into the sampler orifice and flow through the cavity which is maintained at a lower pressure than atmosphere. The cavity also has a separate inlet to introduce a dopant or other types of analytes. FIG. 10B shows the exit of the cavity at the second stage of the MS. All the ion and neutral species are seen to flow out of the cavity and move toward the skimmer orifice to go into the third stage of the MS. The pink light emission is mainly due to the metastable Ar species. FIG. 10C shows a similar case with acetone vapor being injected into the cavity. It can be seen that the metastable species are significantly quenched as manifested by the change of color of the light emitted from the beam.

1. An inductively coupled plasma mass spectrometer (ICP-MS) system, comprising:
an inductively coupled plasma (ICP) source having at least one inlet to receive a background gas and analytes, and to at least partially ionize the background gas and generate a plasma, the plasma comprising of positive and negative ions, meta-stable ions and neutrals, and molecules of the background gas, and free electrons;
a mass spectrometer (MS);
an interface between the ICP source and the MS, comprising of a cavity, the cavity having:
a first cavity inlet fluidically coupled to the ICP source to receive the plasma and the background gas;
a second cavity inlet to receive a dopant and analytes;
a cavity outlet fluidically coupled to the MS;
wherein the cavity is configured to mix and react the dopant, the plasma and the analytes to form a mixture, and to transport the mixture by momentum of the background gas to the cavity outlet,
wherein the plasma is configured to heat the walls of the cavity to prevent the formation of deposits on the walls of the cavity and to help with the transfer of the mixture from the first and second cavity inlets to the cavity outlet,
whereby no electrostatic or magnetic fields is applied inside the cavity to transfer the mixture from the first and second cavity inlets to the cavity outlet.

2. The system of claim 1, wherein the cavity configures a first pressure stage of the system that is maintained at a pressure lower than atmosphere.

3. The system of claim 1, wherein the first and the second cavity inlets are in an off-axis position with respect to the cavity outlet and are configured to enhance mixing inside the cavity and to prevent photons to enter the MS.

4. The system of claim 1, wherein the system has a second pressure stage right after the cavity outlet to receive the mixture.

5. The system of claim 1, wherein the system has a third pressure stage separated by a first orifice from the second pressure stage to receive the mixture.

6. The system of claim 1, wherein the system has a fourth pressure stage separated by a second orifice from the third pressure stage to receive the mixture, the fourth pressure stage further separated by a third orifice from later pressure stages of the MS.

7. The system of claim 1, wherein each of the second, thirds, and fourth pressure stages of the system may have an inlet to receive the dopant or analytes.

8. The system of claim 1, wherein any of the second, third, or fourth pressure stages comprises of an ion guide to contain and focus ions and to transfer the ions to the next stage.

9. The system of claim 1, wherein the ion guides are RF-only ion guides.

10. The system of claim 1, wherein any of the said orifices is a skimmer.

11. The system of claim 1, wherein the dopant is selected to have an ionization energy lower than the energy of the meta-stable neutrals, wherein the energy of the meta-stable neutrals is dissipated into the molecules of the dopant to quench the meta-stable neutrals and to generate dopant ions and free electrons in any of the pressure stages of the system.

12. The system of claim 1, wherein the free electrons ionize the analytes through electron attachment to form negative analyte ions in any of the pressure stages of the system.

13. The system of claim 1, wherein a molecule or ion is negatively ionized by electron attachment, then transfers the electron to the analytes through electron transfer to form negative analyte ions in any of the pressure stages of the system.

14. The system of claim 1, wherein a dopant molecule is negatively ionized by electron attachment, then transfers the electron to the analytes through electron transfer to form negative analyte ions in any of the pressure stages of the system.

15. A method for quenching meta-stable neutrals and generating high yields of negative ions for inductively coupled mass spectrometer (ICP-MS), comprising:
a. injecting a background gas and analytes into an ICP torch to form a plasma comprising of positive and negative ions, meta-stable ions and neutrals, and molecules of the background gas, and free electrons;
b. sampling the plasma into a cavity sustained at a pressure lower than atmosphere through a first cavity inlet;
c. injecting a dopant into the cavity through a second cavity inlet;
d. mixing the plasma and the dopant inside the cavity to quench meta-stable neutrals and form a mixture, and
e. directing the mixture by the momentum of the background gas out of the cavity from a cavity outlet towards a mass spectrometer for analysis.

16. The method of claim 15 wherein the background gas comprises helium (He), nitrogen (N₂), argon (Ar), oxygen (O₂), hydrogen (H₂), air, water vapor or a combination thereof.

17. The method of claim 15, wherein the dopant has an ionization energy lower than the meta-stable energy of the meta-stable neutrals, and wherein for Ar meta-stable neutrals, dopants comprising Butenal, Butene, Butyne, Allene, Acetone, Propene, Hexyne, Ammonia, Pentyne, Hexane, Methylene, Ethylene, Hexane, Formic acid, or a combination thereof react with and quench Ar meta-stable neutrals and become ionized themselves.

18. The method of claim 15, using penning ionization inside the cavity to quench the meta-stable neutrals, wherein an energy of a meta-stable neutral dissipates into the dopant (a reactant partner), causing the reactant partner to ionize and release free electrons, wherein the reactant partner is selected that has an ionization energy less than that of a meta-stable neutral.

19. The method of claim 15, negatively ionizing the analytes inside the cavity by attaching free electrons to the analyte molecules (electron attachment), thereby forming a high yield of negative ions inside the cavity.

20. The method of claim 15, first ionizing a molecule or ion having a lower electron affinity than the analyte molecules through electron attachment, subsequently transferring the electrons from said molecule or ion to the analyte molecules (electron transfer), thereby forming a high yield of negative analyte ions inside the cavity.

21. The method of claim 15, wherein the dopant is injected in a second pressure stage of the MS right after the cavity outlet that is separated from a third pressure stage by an orifice or a skimmer.

22. The method of claim 15, wherein the dopant is injected in a third pressure stage of the MS that is separated from a fourth pressure stage by an orifice.

23. The method of claim 15, wherein the dopant is injected in a fourth pressure stage of the MS that is separated from later stages of the MS by an orifice.

24. The method of claim 15, wherein the dopant is injected in the second pressure stage of the MS that has one ion-guide to contain and focus the ions and transfer them to the third pressure stage.

25. The method of claim 15, wherein the dopant is injected in the third pressure stage of the MS that has one ion-guide.

26. The method of claim 15, wherein the dopant is injected in the fourth pressure stage of the MS that has one ion-guide.

27. The method of claim 15, injecting the analytes to any of the pressure stages of the MS or in a pressure zone between a first and a second skimmers to be negatively ionized through electron attachment or electron transfer, thereby forming a high yield of negative analyte ions.

28. The method of claim 15, bending the ion flow from the first cavity inlet to the cavity outlet skimmer by an off-axis cavity configuration, thereby blocking photons to enter the MS.

29. The method of claim 15, introducing the dopant at any of the pressure stages of the MS, thereby transferring energy from metastable neutrals to the dopant molecules to ionize them, and subsequently, filtering any unwanted ionized species and allowing only ions of interest to enter the MS.

30. The method of claim 15, wherein the dopant or analyte is added in the second, or third, or fourth pressure regions of the MS, wherein introduction of the dopant or the analyte in a RF confinement field generates a high yield of negative ions.
